(19) United States
(12) Patent Application Publication
(10) Pub. No.: US 2026/0320046 A1
(43) Pub. Date: Oct. 15, 2026

(54) ENHANCED, TWO-STAGE QUERY HANDLING TECHNIQUE USING CONTRASTING SIGNALS

(71) Applicant: Optum Services (Ireland) Limited, Dublin (IE)

(72) Inventors: Conor Brian BREEN, Dublin (IE); Kevin LARKIN, Kildare (IE); Shabi Shahul HAMEED, Dublin (IE); Shari A. CHENG, Eden Prairie, MN (US)

(21) Appl. No.: 19/178,269

(22) Filed: Apr. 14, 2025

(51) Int. Cl. G06F 16/2453; G06N 20/00

(52) U.S. Cl. CPC G06F 16/24542; G06N 20/00

(57) ABSTRACT

Various embodiments of the present disclosure provide a query handling process that improves the functionality of a computer in various aspects. The techniques comprise receiving a data request that comprises a target data input and a target contextual attribute for the target data input. The techniques comprise receiving a subset of candidate reference entries, receiving a genericism metric for the candidate reference entries, and generating input vectors for the candidate reference entries by concatenating a similarity metric, a genericism metric, a target contextual attribute, and an entry contextual attribute for up to each of the candidate reference entries. The technique comprises generating, using a machine learned classifier, match probability scores for the candidate reference entries based on the input vector, and, in response to a determination that a match probability score meets or exceeds a similarity threshold, providing the candidate reference entry in response to the data request.

### BACKGROUND

In many domains, data queries are provided between systems to retrieve, verify, or invalidate information for a subject entity. In such cases, a common understanding of the identity of the subject entity is necessary to accurately process the query. This causes several technical challenges in computer systems that maintain different, localized versions of data that may have divergent identities for the same entity. To address these challenges, some systems implement data matching techniques to match entities across datasets. However, these too are subject to several limitations.

Particularly, traditional data matching techniques may rely on exact or fuzzy string matching algorithms, which are limited in their accuracy when dealing with complex real-world data. For example, such approaches may (i) result in multiple data matches for the same entity due to generic or similar samples across multiple distinct entities, (i) fail to account for contextual information to distinguish between two, textually similar entities, (iii) lack the ability to adapt to evolving data patterns and variations in naming conventions over time, among other limitations.

These limitations are traditionally handled using brute force querying methods in which a data source is queried until a correct entity is derived. Such methods require extensive computing resources and cause network traffic congestion, which may lead to network delays, packet loss, slow performance, among other reductions in the functionality of a computer. In other cases, existing data matching techniques may require manual intervention to resolve ambiguous matches, which suffers from scalability issues and increases the time and resources required for query processes.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a two-stage query handling technique in accordance with some embodiments of the present disclosure.

FIG. 5 depicts a dataflow diagram of a classifier training technique accordance with some embodiments of the present disclosure.

FIG. 6 depicts a flowchart diagram of two-stage query handling process in accordance with some embodiments of the present disclosure.

### DETAILED DESCRIPTION

Various embodiments of the present disclosure provide improved data matching techniques that enhance the functionality of computer systems with respect to query processing, among other functionalities. To do so, some embodiments of the present disclosure provide a two-staged query handling framework that divides a data matching process into two sequential operations designed to balance a similarity between two entries with contextual features of the two entries. For example, in a first, search stage, the two-staged query handling framework may generate similarity metrics between a target data input and a set of reference entries within a reference dataset. In the event that multiple reference entries achieve a similarity criteria based on the similarity metrics (e.g., which would typically lead to ambiguous matches), the two-staged query handling framework may pass the reference entries to a second, refinement stage instead of returning ambiguous matches. In the refinement stage, the similarity metrics may be combined with counterbalancing features, such as a genericism metric, and/or other contextual attributes, to create an input vector for a machine learned model. The machine learned model may be trained to output a match probability score that balances the magnitude of the similarity metrics with these counterbalancing features. In this way, the two-staged query handling framework may improve the accuracy, generalizability, and scope of traditional data matching techniques, while handling edge cases that traditionally limit the applicability of such techniques. By doing so, the two-staged query handling framework may be integrated within a query handling process to accurately match data entities before executing a query to a remote data source. This, in turn, improves the speed, efficiency, and resolution accuracy for queries executed to remote data sources, which may lead to reduced network congestion, reduced processing resource requirements, among other improvements to a computer's functionality.

More particularly, some embodiments of the present disclosure implement a multi-stage data matching process that combines similarity metrics, such as direct or fuzzy string matching techniques, with a genericism metric and contextual attributes to generate more accurate matches while reducing computational resources. To overcome limitations of traditional data matching techniques, the multi-stage data matching process employs a machine learned classifier that is trained to optimize feature interactions between similarity metrics and counterbalancing metrics, such as a genericism metric measuring the frequency of occurrences of a particular reference within a reference dataset. By doing so, the machine learned classifier may be trained to differentiate between generic and unique references, improving match accuracy in cases where simple string matching may be insufficient. In addition, or alternatively, by incorporating contextual attributes, such as geographic location data, the machine learned classifier may further refine its predictions, leading to more reliable data validation outcomes compared to direct or fuzzy string matching.

In some embodiments, the two-staged query handling framework implements an intermediate lookup table for a reference dataset to further enhance the speed of query resolutions, while reducing network congestion. The intermediate lookup table, for example, may comprise a set of partial reference entries from a reference dataset that each comprise sufficient data to locally determine a set of counterbalancing features for a similarity metric. By doing so, the two-staged query handling framework enables the preemptive determination genericism metrics for reference entries within a reference dataset without access to the reference dataset. This, in turn, allows for a localized query handling process that may refine a query before accessing the reference dataset. In some examples, the two-staged query handling framework may asynchronously (e.g., with respect to queries) access the reference dataset to update the intermediate lookup table at defined intervals. In this manner, the two-staged query handling framework may optimize the balance between computational efficiency and data freshness, ensuring that the matching process remains accurate over time without incurring excessive processing overhead.

In some embodiments, the multi-stage data matching process is complemented by a classifier training framework designed to train the machine learned classifier for the data matching process. The classifier training framework addresses challenges, such as overfitting, that are specific to data matching by modifying the training data used to train the machine learned classifier. Specifically, to prevent overfitting to the most predictive features within the data, namely the similarity metrics, the classifier training framework may generate a labeled training dataset comprising both positive and negative samples. Both the positive and negative samples may comprise varying similarity scores to encourage the model to learn feature interactions with counterbalancing features, instead of overfitting to the similarity metrics themselves. In some examples, the negative samples may be further divided into high-similarity and/or low-similarity subsets to enable the classifier to better distinguish between truly matching entries and those that are similar but distinct, reducing false positives and improving overall accuracy. In this manner, the classifier training framework may enable the training of a model and that is capable of considering a similarity metric without overfitting to the similarity metric. This, in turn, allows for the integration of the machine learned classifier within a data matching process that enhances, rather than attempting to replace, traditional data matching techniques.

In some embodiments, the classifier training framework further enhances the performance (e.g., in terms of accuracy) of a machine learned classifier by integrating real world feedback into an active learning pipeline. For example, the classifier training framework may receive passive and/or active feedback for labeling one or more training samples based on real world data. In this way, the classifier training framework may adapt to evolving data patterns and variations in naming conventions over time, which may improve the adaptability of the machine learned model. In some examples, to consider real world data, while maintaining a defined distribution of positive and negative samples, the classifier training framework may introduce synthetic negative training samples to a real world dataset. The synthetic negative training samples, for example, may be generated by perturbing input data to increase similarity metrics, allowing the machine learned classifier to learn to identify subtle differences between closely related but distinct real world entries. This, in turn, may improves the machine learned classifier's performance in edge cases and contributes to a more reliable data matching process.

Examples of technologically advantageous embodiments of the present disclosure comprises a distribution of functionality within a query processing pipeline that operates in an unconventional fashion (e.g., by verifying a reference entry before initiating a query) to reduce network congestion, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

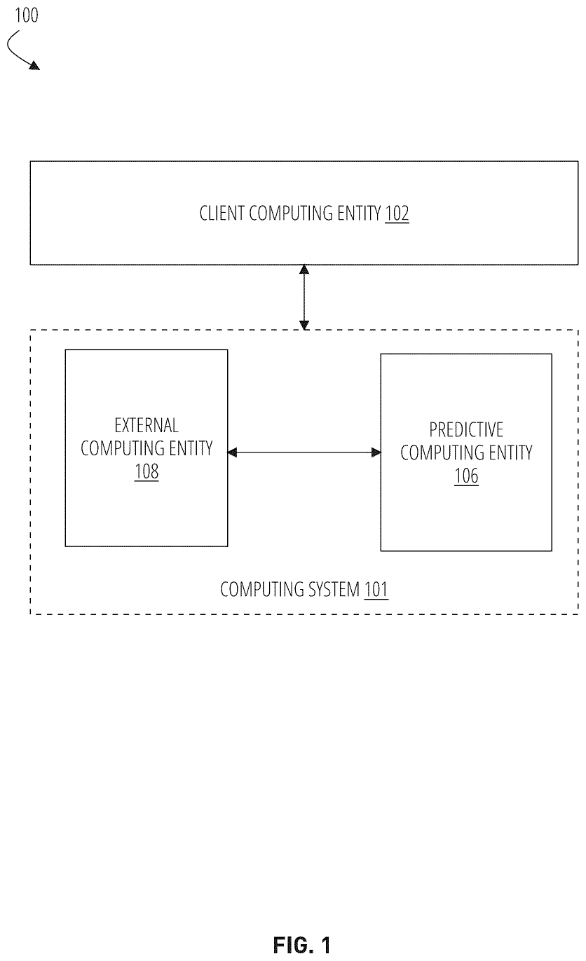

FIG. 1 depicts a block diagram of an example architecture 100 in accordance with some embodiments of the present disclosure. The architecture 100 comprises a computing system 101 configured to receive a request, such as a data request, and/or the like, from client computing entities 102, process the request, and provide a query, query resolution, and/or the like, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a query handling engine and/or two-stage query handling framework that may collectively process a request using the models. Some techniques of the present disclosure may adapt traditional models to a query processing framework for more efficiently handling portions of the query handling process.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code prediction, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., query handling, data matching techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like, to the predictive computing entity 106 which may leverage the datasets, such as the reference dataset, the intermediate lookup table, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

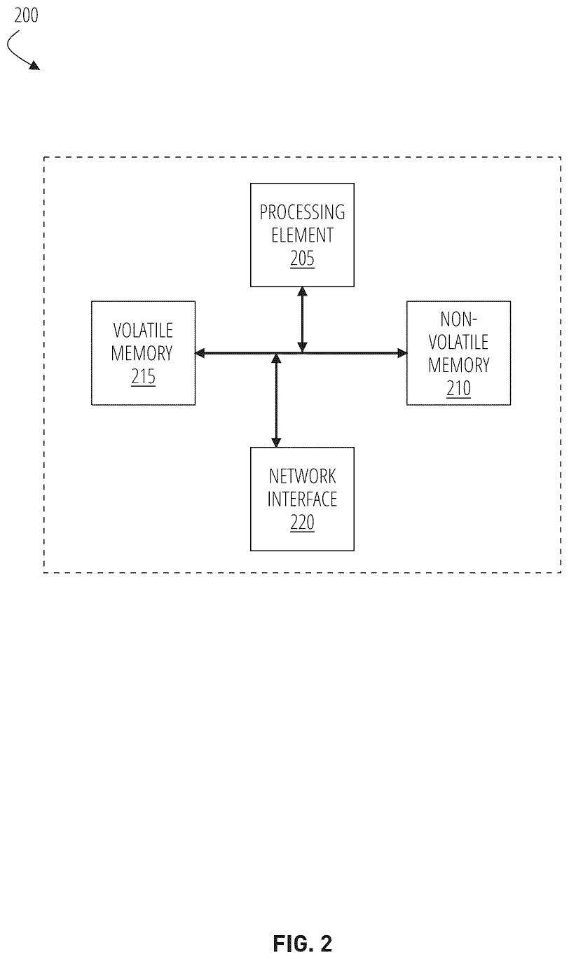

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

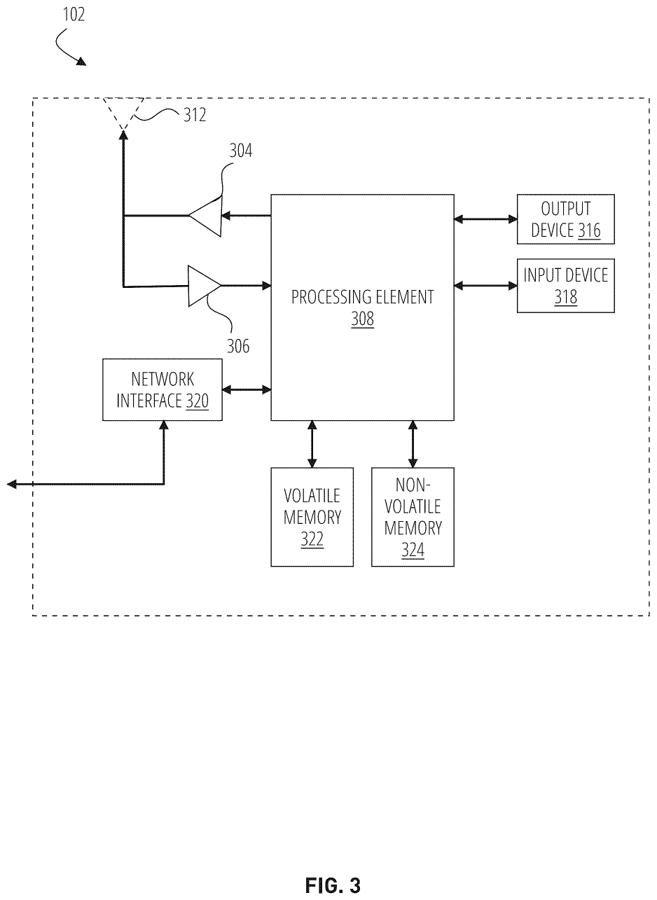

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality, such as query handling. In particular, systems and methods are disclosed herein that implement machine learning, query handing, and data matching techniques to improve data retrieval, storage, and matching operations in distributed computing environments. By doing so, the machine learning, query handing, and data matching techniques of the present disclosure enable improved data storage and retrieval processes that, when executed on a computer, improves computer resource allocation, reduces network congestion, among other technical benefits. This, in turn, may improve the functionality of a computer with respect to various computing tasks, including data security, machine learning training, network communication, and the like.

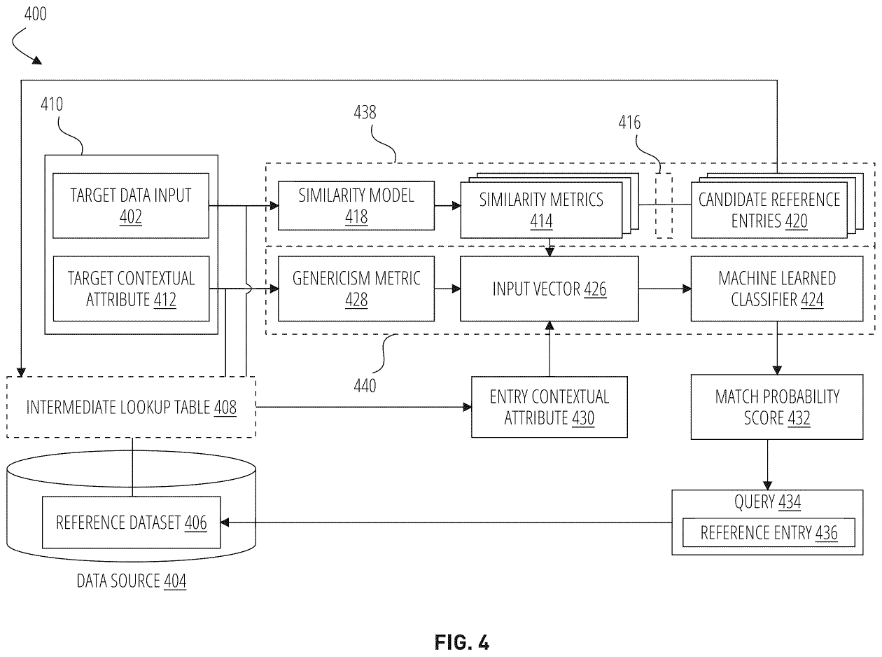

FIG. 4 depicts a dataflow diagram of a two-stage query handling framework 400 in accordance with some embodiments of the present disclosure. The two-stage query handling framework 400 comprises a search stage 438 and a refinement stage 440. When implemented by a computing system, such as the computing system 101, the two-stage query handling framework 400 may improve data retrieval speeds as well as the actual resolution accuracy, and the confidence in the actual resolution accuracy, of queries executed by the computing system 101. This is accomplished by integrating direct similarity comparisons, such as string similarity metrics, within a first, search stage 438 of the two-stage query handling framework 400. This, first, search stage 438 may be implemented as an initial processing operation to reduce a search space for a subsequent, refinement stage 440. During the refinement stage 440, the similarity comparisons may be merged with counter balancing features, such a genericism metrics 428, to balance a magnitude of similarity between two entities against countervailing factors that traditionally reduce the accuracy of similarity-based matching approaches. In this way, the two-stage query handling framework 400 allows for specific queries 434 to a data source 404 that identify a reference entry 436 with greater accuracy, thereby reducing null or redundant query operations.

In some embodiments, the computing system 101 receives a data request 410 that comprises a target data input 402 and/or a target contextual attribute 412 for the target data input 402. The target data input 402, for example, may comprise a text string, a bounding box, and/or an audio snippet that may correspond to an entry name of a reference entry 436 within a data source 404.

In some embodiments, the data request 410 is a request for more information and/or a verification of information for an entity. A data request 410 may be initiated by the computing system 101 to obtain and/or verify specific details about an entity from an external data source, such as the data source 404. The data source 404, for example, may comprise an up-to-date repository of information for a reference dataset 406, allowing for the retrieval of current and/or accurate data through queries 434 to the data source 404.

The data request 410 may comprise any type of request message, such as an API (Application Programming Interface) call, a database query, and/or the like. In some examples, the data request 410 may be executed as an HTTP request to a RESTful API endpoint, as an SQL query to a relational database, and/or the like. By way of example, the data request 410 may comprise a structured message that requests data for a target data input 402 from the data source 404. If sent directly to the data source 404, the data request 410 may be matched to zero, one, or a plurality of reference entries within a reference dataset 406. To prevent null results, and reduce the retrieved data to a single reference entry, the computing system 101 may preprocess the data request 410 by applying the two-stage query handling framework 400 to match the target data input 402 to a single reference entry 436 of the reference dataset 406 before requesting data from the data source 404.

The data request 410 may comprise one or more different data elements depending on the use case. For example, in a clinical use case, a data request 410 may comprise a request to verify an employer size of an employer associated with a health insurance policy. In such a case, the data request 410 may comprise an employer name as recorded within a patient's clinical records. As another example, in a computer security domain, a data request 410 may comprise a request to verify an access credential of a user. In such a case, the data request 410 may comprise a user signal, such as a facial recognition image, a username typed by the user, a voice recording, and/or the like, which may represent an entity's presence within an environment.

In some examples, the data request 410 comprises a target data input 402 and/or one or more target contextual attributes to support a data retrieval task for an entity. The target data input 402, for example, may comprise to a segment of text, audio, and/or imagery that identifies an entity for which information is requested. The target data input 402, for example, may comprise the primary identifier within a data request 410. For example, in a company name matching process, the target data input 402 may comprise a text string recording at least a portion of the company name, which may be subject to errors that reduce the effectiveness of direct or fuzzy string matching techniques. As another example, in a user signal matching process, the target data input 402 may comprise a facial recognition image, a username, a voice recording, and/or the like that is recorded within an environment.

In some examples, in the event that the target data input 402 comprise audio and/or imagery, the computing system 101 may apply one or more feature extraction techniques, such as mel-frequency cepstral coefficients (MFCCs), convolutional neural networks (CNNs), and/or the like to convert the audio and/or imagery to a text and/or other data format for the two-stage query handling framework 400. In any format, the target data input 402 may be leveraged as the basis for querying the reference dataset 406 and/or initiating the two-stage query handling framework 400 before querying the reference dataset 406.

The target contextual attribute 412 may comprise contextual information that is available for the target data input 402, such as location information that identifies a geographic area associated with the target data input 402 and/or the data request 410. The target contextual attribute 412 may provide additional dimensions of information that may be used to refine and improve the accuracy of data matching processes during the refinement stage 440. In some examples, a target contextual attribute 412 may comprise a key-value pair, structured data field, natural language text, and/or the like, within a larger data object, such as a clinical record, access record, monitoring profile, and/or the like. The target contextual attributes 412 may comprise any data type, including strings, numbers, and/or more complex structures, such as geospatial coordinates. By way of example, the target contextual attributes 412 may comprise a geographic attribute (e.g., geographic region, state, city, residential location, recording location), a policy attribute, a group attribute, and/or the like. As described herein with reference to the refinement stage 440, the target contextual attributes 412 may serve as additional features for a machine learning model, allowing the computing system 101 to consider contextual information when determining the likelihood of a match.

In some embodiments, the data request 410 comprises the target data input 402 as an intended reference to a specific reference entry 436 within a reference dataset 406 to pull information stored in association with the reference entry 436.

In some embodiments, the reference dataset 406 is a repository of reference entries that is maintained by the data source 404. The reference dataset 406, for example, may comprise a comprehensive and authoritative source of information against which entity data may be matched, verified, and/or rejected. For example, the reference dataset 406 may serve as a primary source of truth in a data matching and/or verification processes. The reference dataset 406 may provide a standardized and/or curated set of entity information, enabling efficient search and retrieval of relevant entries, and supporting regular updates to maintain data freshness and accuracy. In some examples, the reference dataset 406 may be implemented as a large-scale database system. This could be a relational database management system (RDBMS) for structured data, a NoSQL database for more flexible, semi-structured data, a distributed file system (HDFS), and/or the like. In addition, or alternatively, the reference dataset 406 may comprise a hybrid system that combines multiple data sources, and/or federated databases that allow querying across distributed data stores. Some data sources 404, for example, may implement caching layers and/or materialized views to optimize frequently accessed subsets of the reference dataset 406, improving query performance for common matching scenarios.

In some embodiments, a reference entry 436 is an entry (e.g., a row, node) within a reference dataset 406 that identifies an entity and/or verified information for the entity. A reference entry serves as a single, comprehensive record of information about a specific entity, containing various attributes and/or identifiers that may be used for matching and/or verification purposes. The reference entry may be implemented as a data structure within the reference dataset 406. In a relational database, for example, the reference entry 436 may comprise a row in a table, with each column representing a different attribute. In a document-based NoSQL database, a reference entry 436 may comprise a JSON document with nested fields. For graph databases, a reference entry 436 may comprise a node with properties and/or relationships to other nodes.

A reference entry 436 may be used as the basis for comparison in the two-stage query handling framework 400. In some examples, one or more attributes of up to each reference entry 436 within the reference dataset 406 may be retrieved and/or evaluated against target data inputs 402 to determine potential matches. For example, a reference entry 436 may comprise an entry name and/or one or more entry contextual attributes 430. The entry name may comprise a data element that is the same data type (e.g., a string, audio, imagery) as the target data input 402, which may be used as a basis for a direct similarity comparison, as discussed with reference to the search stage 438 of the two-stage query handling framework 400. The one or more entry contextual attributes 430 may comprise additional data elements, such as those described with reference to the target contextual attributes, that may provide contextual information for the entry name, which may be used as counterbalancing features for a refined similarity comparison, as discussed with reference to the refinement stage 440 of the two-stage query handling framework 400.

In some embodiments, the reference dataset 406 is stored within a data source 404. The data source 404 may comprise an external data source 404 and/or an internal data source 404. For example, the data source 404 an external data source 404 that maintains up to date information for up to each entity within a reference dataset 406. The data source 404, for example, may comprise a data aggregator for a particular domain and/or a particular attribute within the domain. By way of example, in a company name matching process, the data source 404 may comprise a company data aggregator, such as Orbis, Dun & Bradstreet, Judy Diamond, and/or the like, that aggregates data for a set of companies within company profiles. As another example, in a user signal matching process, the data source 404 may comprise a user information aggregator, such as a surveillance server, that aggregates data for a set of users.

In some embodiments, in the event that the data source 404 is an external data source, the computing system 101 comprises an intermediate lookup table 408 for the data source 404 and/or the reference dataset 406 thereof. The intermediate lookup table 408 may comprise a localized container storing at least a portion of the reference dataset 406 of the data source 404. In some examples, the intermediate lookup table 408 may be updated at a defined frequency to ensure an up to date representation of the data stored within the data source 404.

In some embodiments, the intermediate lookup table 408 comprises a data structure, such as a lookup table, that is locally stored by the computing system 101 and used to store predetermined metrics, such as genericism metrics 428, from an external data source 404. The intermediate lookup table 408, for example, may comprise a clone, or partial, reference entry for up to each reference entry within the reference dataset 406. The clone, or partial, reference entry may comprise at least a subset of a set of entry attributes for the reference entry, including the entry name and/or one or more entry contextual attributes, such as a geographic location. In some examples, the clone reference entry may be augmented with one or more additional, precomputed attributes, such as a genericism metric 428, as described herein.

In this way, the intermediate lookup table 408 may serve as a cache and/or local copy of frequently accessed data, improving performance and reducing the need for repeated queries to external data sources 404. By way of example, the intermediate lookup table 408 may be leveraged by the two-stage query handling framework 400 to refine a query 434 (e.g., by identifying the correct reference entry) before accessing the data source 404. In some examples, the intermediate lookup table 408 may be implemented as an in-memory data structure, local database, and/or the like. For instance, the intermediate lookup table 408 may comprise a hash table for fast key-based lookups, a B-tree for efficient range queries, a lightweight database, such as SQLite for more complex query patterns, a graph database, and/or any other data structure.

The intermediate lookup table 408 may be used to store and quickly retrieve precomputed metrics and/or attributes for up to each of a set of reference entries within the reference dataset 406. By doing so, the intermediate lookup table 408 enables rapid access to frequently used data, reducing the load on external data sources 404, and supporting more responsive and efficient matching operations. In this way, the intermediate lookup table 408 may reduce processing times for the two-stage query handling framework 400 and enable real time query processing. For example, by locally storing precomputed attributes, the intermediate lookup table 408 may reduce the latency and computational overhead of the two-stage query handling framework 400.

In some embodiments, the intermediate lookup table 408 is updated, asynchronously with request to data requests 410, at a defined frequency. The define frequency, for example, may be set based on one or more attributes of a particular domain, and/or the data source 404 within the domain. For example, the defined frequency may be dynamically adjusted based on the rate of change in the underlying data, the patterns of access to the data source 404, a rate of data requests 410 observed in the computing system 101, and/or the like. In some examples, the defined frequency may comprise one or more hours, days, weeks, months, and/or the like.

In some embodiments, during the search stage 438, the computing system 101 receives a subset of candidate reference entries 420 from the reference dataset 406 based on the target data input 402. Up to each candidate reference entry 436 of the subset of candidate reference entries 420 may be associated with a similarity metric 414 that meets or exceeds a first similarity threshold 416. For example, in a text processing use case, the target data input 402 may comprise a text string and the similarity metrics 414 may comprise a Levenshtein distance and/or a Jacquard distance between the target data input 402 and an entry name of up to each reference entry within the intermediate lookup table 408 and/or reference dataset 406 of the data source 404. For example, the computing system 101 may access the intermediate lookup table 408 and/or reference dataset 406 to receive the subset of candidate reference entries 420.

In some embodiments, the search stage 438 of the two-stage query handling framework 400 applies a similarity model 418 to the target data input 402 and up to each of the reference entries within the reference dataset 406 and/or intermediate lookup table 408 to extract a receive subset of candidate reference entries 420 that achieve a first similarity threshold 416. The candidate reference entries 420, for example, may be determined based on a comparison between a set of similarity metrics 414, generated according to the similarity model 418, and the first similarity threshold 416.

In some embodiments, the similarity metric 414 comprises a direct measure of similarity between a target data input 402 and an entity name of a reference entry 436. For example, the similarity metric 414 may comprise a similarity measurement that measures text-, image-, and/or audio-based similarity between a target data input 402 and an entry name of a reference entry 436. A similarity metric 414, for example, may comprise a quantitative measure of how closely a target data input 402 matches a reference entry 436. Traditionally viewed as the sole factor for data matching processes, the two-stage query handling framework 400 applies the similarity metric 414 as a baseline criteria that is counterbalanced by additional metrics in a refinement stage 440 of the two-stage query handling framework 400.

A similarity metric 414 may be determined using a similarity model 418 that is configured for a data type of the target data input 402 and/or reference entry 436. The similarity model 418, for example, may comprise a machine learning and/or rule-based function configured to generate a numerical score based on a comparison between the features (e.g., characters in text, pixels in images) of the target data input 402 and the reference entry 436. By way of example, for text data, the similarity model 418 may comprise a Levenshtein distance function, Jaccard similarity function, cosine similarity function for word embeddings, and/or the like. In such a case, the similarity metric 414 may comprise a Levenshtein distance, Jaccard similarity, and/or cosine similarity. As another example, for image and/or audio data, the similarity model 418 may comprise a contrastive language-image pre-training model, a wav2vec model, and/or the like, and the similarity metric 414 may comprise an embedding similarity, such as a cosine similarity, between the target data input 402 and the reference entry 436.

In some embodiments, the first similarity threshold 416 is a cutoff similarity measurement for the search stage 438. The first similarity threshold 416, for example, may serve as a decision boundary for extracting a subset of candidate reference entries 420 from the reference dataset 406. The first similarity threshold 416 may comprise a configurable parameter within the computing system 101. It may be stored as a constant in the application code, and/or as a configurable value in a database and/or configuration file. In some examples, the first similarity threshold 416 may be dynamically adjusted based on factors, such as data distribution, system performance metrics, and/or the like.

The first similarity threshold 416, in combination with the similarity metrics 414, may be used to constrain a search space for a refinement stage 440 of the two-stage query handling framework 400. For instance, the first similarity threshold 416 may define a first filter for an initial set of potential matches, reducing the number of reference entries that need to be processed in subsequent, more computationally intensive stages of the two-stage query handling framework 400. In some examples, the first similarity threshold 416 may be configured to balance recall (e.g., not missing potential matches), precision (e.g., avoiding too many false positives), and null results (e.g., avoiding null results). For example, by using a subsequent refinement stage 440, the two-stage query handling framework 400 may lower the first similarity threshold 416 (e.g., compared to traditional similarity matching processes) to reduce null results, without negatively impacting the overall recall and precision of the two-stage query handling framework 400. By way of example, where traditional data matching techniques may require a similarity metric 414 above 0.7, the first similarity threshold 416 may be set to 0.5 to encourage broader initial search results without negatively impacting system performance.

In some examples, the first similarity threshold 416 may comprise a plurality of thresholds for one or more different similarity metrics, data types, and/or the like. In addition, or alternatively, the first similarity threshold 416 may comprise an adaptive threshold that adjusts based on the characteristics of the input data, the current system load, and/or the like. In some examples, the computing system 101 may leverage a probabilistic threshold, where the decision to include a reference entry as a candidate reference entry 420 may be based on a probability distribution rather than a fixed cutoff value.

In some embodiments, a candidate reference entry 420 comprises a reference entry that is down selected from the set of reference entries within the reference dataset 406 for a particular target data input 402 during the search stage 438 of the two-stage query handling framework 400. A candidate reference entry 420, for example, may comprise a potential match that has been identified based on initial similarity criteria, typically through a fuzzy matching process and/or other preliminary filtering mechanism applied during the search stage 438, as described herein. The candidate reference entries 420 may comprise a subset of the full reference dataset 406 that is passed to the second, refinement stage 440 of the two-stage query handling framework 400. In some examples, the number of candidate reference entries 420 may be constrained by the first similarity threshold 416. In addition, or alternatively, the number of candidate reference entries 420 may be further constrained by a search size limit (e.g., 5, 10, 100) that defines a maximum size of the candidate reference entries 420.

In some embodiments, during the refinement stage 440, the computing system 101 receives a genericism metric 428 for the candidate reference entry 436. In some embodiments, the refinement stage 440 of the two-stage query handling framework 400 leverages the outputs (e.g., similarity metrics 414) of the similarity model 418 as one of a set of counterbalancing signals for a reference entry 436. To do so, the computing system 101 may incorporate the similarity metrics 414 as one feature of an input vector 426 for a downstream machine learned classifier 424 that may be counterbalanced with other features of the input vector 426, such as the genericism metric 428.

In some embodiments, the genericism metric 428 is based on a frequency of at least a portion of the entry name of the reference entry 436, such that the genericism metric 428 may counterbalance a similarity between the target data input 402 and a reference entry 436 based on a prevalence of the reference entry 436 within the reference dataset 406.

In some embodiments, the genericism metric 428 comprises a frequency measurement that is configured to counterbalance the similarity metric 414 for a reference entry 436. The genericism metric 428, for example, may comprise a measure of how common and/or generic a particular entry name, and/or portion thereof, is within the reference dataset 406, which may increase or decrease the significance of the similarity metric 414 to improve the accuracy of the matching process.

The genericism metric 428 may comprise a statistical measure derived from the reference dataset 406. For example, the genericism metric 428 may comprise a Term Frequency-Inverse Document Frequency (TF-IDF) score, and/or the like, of the entry name, and/or portion thereof, within a reference dataset 406. In some examples, the genericism metric 428 may be determined using a unique portion of an entry name, such as “Liberty” in the entity name “Liberty LLC”. To do so, the entity names for up to each of the candidate reference entries 420 may be preprocessed to remove a set of defined terms, such as LLC, Corp., and/or the like in a company name matching process.

In some examples, the genericism metric 428 may be used in conjunction with similarity metrics 414 to improve the accuracy of matching processes, particularly for entities with common and/or generic names. For example, as described herein, the genericism metric 428 may serve as an additional feature in machine learning models used for matching, helping to distinguish between truly matching entries and coincidentally similar but distinct entries. In this way, the genericism metric 428 may provide a counterbalance to direct similarity measures, improving the computing system's 101 ability to handle ambiguous cases, and contributing to more nuanced confidence scores in the matching process.

In some embodiments, the genericism metric 428 comprises a local genericism measure that is localized to the data request 410. For example, the target contextual attribute 412 and/or an entry contextual attribute 430 of the reference entry 436 may identify a geographic location. The genericism metric 428 may be based on a frequency of at least the portion of the entry name within a subset of the reference dataset 406 that corresponds to the geographic location.

By way of example, the genericism metric 428 may comprise context-sensitive measures that consider factors, such as industry, geography, environment, and/or the like, when determining how generic an entry name is. For instance, a genericism metric 428 may comprise is a relative TF-IDF score for an entry name, and/or portion thereof, within a subset of the reference dataset 406 that corresponds to a particular geographic location. In some examples, the computing system 101 may determine one genericism metric 428 for a reference entry 436 that is relative to the entry contextual attribute 430 of the reference entry 436. In addition, or alternatively, the computing system 101 may determine a set of genericism metrics 428 for a reference entry 436 that is relative to up to each of the contextual attributes within the reference dataset 406. In some examples, the computing system 101 may predetermine genericism metrics 428 for up to each of the reference entries within the reference dataset 406 at the defined frequency and store the genericism metric 428 within the intermediate lookup table 408 for quick retrieval. In addition, or alternatively, the computing system 101 may implement dynamic genericism metrics 428 that may be updated in real-time as new data is added to the reference dataset 406 and/or determined, on the fly, in response to a data request 410.

In some examples, the genericism metric 428 may be received from the intermediate lookup table 408. For example, the intermediate lookup table 408 may comprise a predetermined genericism metric 428 for up to each reference entry 436 within the reference dataset 406. In addition, or alternatively, genericism metric 428 may be received from the data source 404. In some examples, the genericism metric 428 may be generated on the fly from either the intermediate lookup table 408 and/or the reference dataset 406 of the data source 404.

In some embodiments, during the refinement stage 440, the computing system 101 generates an input vector 426 for the candidate reference entry 436 by concatenating the similarity metrics 414, the genericism metric 428, the target contextual attribute 412, and an entry contextual attribute 430.

In some embodiments, the input vector 426 comprises a vectorized input for a machine learned classifier 424 that encodes a set of matching features within a vector representation (e.g., numerical array, tensor). An input vector 426 serves as a comprehensive and structured representation of counterbalancing features interpretating the matching likelihood of a reference entry 436 to the target data input 402. The input vector 426, for example, may correspond to a single reference entry 436. In some examples, a different input vector 426 may be generated for up to each of the subset of candidate reference entries 420 to separately assess the match likelihood of the candidate reference entries 420.

In some examples, an input vector 426 encapsulates a set of predictive features for a reference entry 436 and/or a target data input 402. The set of predictive features, for example, may comprise the similarity metric 414, genericism metric 428, and/or the contextual attributes (e.g., target contextual attribute 412, entry contextual attributes 430) associated with the reference entry 436 and/or the target data input 402. The set of predictive features may be arranged in a particular format that is provided to the machine learned classifier 424 during training. In this way, the input vector 426 may enable the machine learned classifier 424 to consider multiple factors simultaneously when determining the likelihood of a match, supporting more nuanced and accurate matching decisions compared to simpler rule-based approaches.

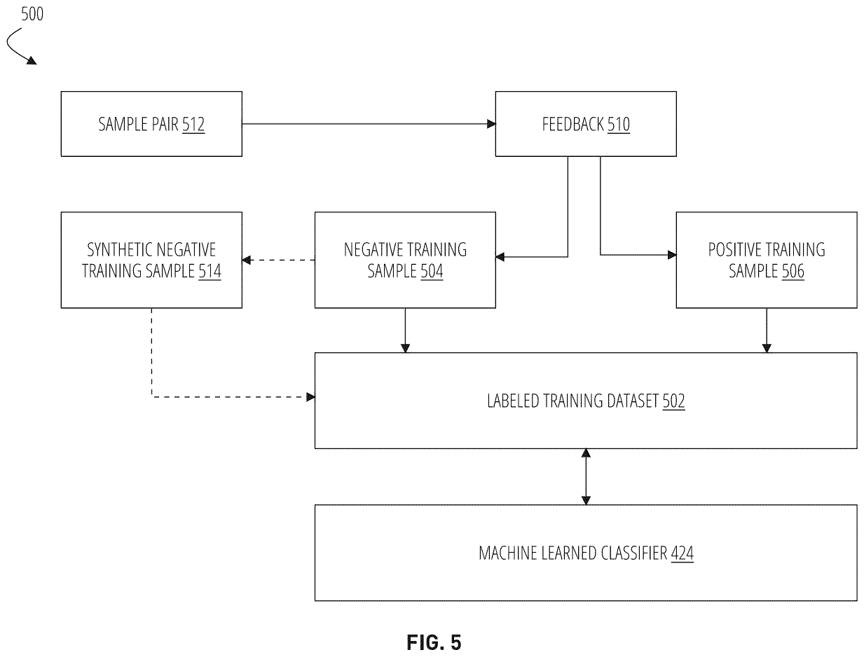

In some embodiments, during the refinement stage 440, the computing system 101 generates, using a machine learned classifier 424, a match probability score 432 for the candidate reference entry 436 based on the input vector 426. In some embodiments, the machine learned classifier 424 comprises a machine learning model of any classifier architecture, such as a logistic regression model, a neural networks (e.g., feedforward neural network), random forests, gradient boosting machines, support vector machines, and/or the like. In any architecture, the machine learned classifier 424 may be trained, using the techniques of described with reference to FIG. 5, to learn patterns from training data and make predictions about the likelihood of a match between a target data input 402 and a reference entry 436.

In some embodiments, the machine learned classifier 424 processes an input vector 426 to generate a match probability score 432. The match probability score 432 may comprise a probabilistic score output by the machine learned classifier 424 that identifies a probability of a match between a target data input 402 and the reference entry 436 associated with an input vector 426. In this way, the match probability score 432 may provide a quantitative measure of confidence in a potential match, allowing for more nuanced decision-making in the matching process. For example, the match probability score 432 may be implemented as a floating-point number between 0 and 1, representing the probability of a match as estimated by the machine learning model. In binary classification models, the match probability score 432 may comprise the output of a sigmoid function applied to the raw predictions of the machine learned classifier 424.

In some embodiments, a match probability score 432 is used as the basis for an output of the two-stage query handling framework 400. For example, the match probability score 432 may comprise a standardized and normalized measure for comparing and/or ranking the subset of candidate reference entries 420. In some examples, the match probability score 432 may be thresholded to make binary match/no-match decisions. In addition, or alternatively, the computing system 101 may make a binary match/no-match decision based on a comparison between the match probability scores 432 for up to each of the subset of candidate reference entries 420. For example, a highest match probability score 432 may be chosen as the match.

In some embodiments, the computing system 101, in response to a determination that the match probability score 432 meets or exceeds a second similarity threshold, provides the reference entry 436 in response to the data request 410. In some embodiments, the second similarity threshold (e.g., 0.7, 0.9, 0.95) comprises a cutoff similarity measurement for the refinement stage 440 of the two-stage query handling framework 400. The second similarity threshold, for example, may serve as a decision boundary for determining whether a candidate reference entry should be considered a match based on the output of the machine learned classifier 424. In some examples, the second similarity threshold may comprise a configurable parameter within the computing system 101. The second similarity threshold may be separate than the first similarity threshold. It may be stored as a constant in the application code, or as a configurable value in a database and/or configuration file. In some examples, second similarity threshold may be dynamically adjusted based on factors, such as the desired precision-recall trade-off and/or the specific requirements of downstream processes.

In some examples, the second similarity threshold may be used to make final decisions about whether to consider a candidate reference entry as a match and plays a crucial role in balancing between false positives and false negatives in the two-stage query handling framework 400. In some examples, the computing system 101 leverages the second similarity threshold as a first of one or more output criteria for the two-stage query handling framework 400. For example, a reference entry 436 may be output from the two-stage query handling framework 400 in response to (1) a match probability score 432 meeting or exceeding the second similarity threshold and (2) the match probability score 432 meeting or exceeding all other match probability score 432 for the other candidate reference entries in a subset of candidate reference entries 420.

In some examples, the second similarity threshold may comprise a plurality of thresholds to categorize matches into different confidence levels. In addition, or alternatively, the second similarity threshold may comprise adaptive thresholds that may be adjusted based on the distribution of match probability scores for a given target data input 402. In some examples, the computing system 101 may implement probabilistic thresholds, where the decision to consider a match is based on sampling from the probability distribution rather than a fixed cutoff value.

In some embodiments, the reference dataset 406 is stored on an external data source 404. The computing system 101 may, in response to the determination that the match probability score 432 meets or exceeds the second similarity threshold, generate a query 434 for the external data source 404 based on the reference entry 436. The computing system 101 may execute the query 434 to receive and/or verify an attribute of the target data input 402 based on the data stored in association with the reference entry 436.

In some embodiments, the query 434 comprises message to an external data source 404 to verify and/or obtain new information for a target data input 402. The query 434, for example, may serve as a mechanism for retrieving additional data and/or verifying existing information, enhancing the matching process with up-to-date and/or comprehensive data from authoritative sources. By way of example, the query 434 may comprise a structured request to an external API and/or database, such as an HTTP request, SQL statements, API call, and/or the like. The query 434 may be executed to verify information for an entity that is designated within the computing system 101 by the target data input 402. By applying the two-stage query handling framework 400, the computing system 101 may first covert the target data input 402 to a specific reference entry 436 within the reference dataset 406. By doing so, the computing system 101 may generate a query 434 that references a known reference entry 436, rather than a potentially unknown or ambiguous target data input 402. This, in turn, enables faster query processing times and increase the accuracy of query resolutions from the data source 404.

FIG. 5 depicts a dataflow diagram of a classifier training framework 500 accordance with some embodiments of the present disclosure. The classifier training framework 500 may be implemented by a computing system, such as the computing system 101, to train a machine learned classifier 424 for a refinement stage of the two-stage query handling framework. To improve the performance (e.g., in terms of accuracy, precision, and recall) of the machine learned classifier 424, the classifier training framework 500 may generate a labeled training dataset 502 that may combine distributions of positive and negative samples to prevent overfitting to highly predictive features, such as the similarity metrics expected in the search stage of the two-stage query handling framework. The classifier training framework 500 may generate the labeled training dataset 502 from real world data using feedback 510 to automatically label sample pairs 512. In this way, the labeled training dataset 502 may automatically adjust to changes in data over time. To maintain a specific distribution of samples within the labeled training dataset 502, the classifier training framework 500 may generate synthetic negative training samples by selectively perturbing the features of real world samples. In this way, the classifier training framework 500 enables a machine learning process that benefits from real world data, while preemptively addressing machine learning performance deficiencies that, if left unchecked, may lead to overfitting to undesirable features, such as the similarity metrics intended to be counterbalanced by the other features within an input vector.

In some embodiments, the machine learned classifier 424 comprises a binary classifier that the computing system 101 trains using a labeled training dataset 502. The labeled training dataset 502 may comprise a first subset of positive training samples and/or a second subset of negative training samples. In some examples, the positive and negative training samples may comprise sample pairs 512 that may be labeled using active and/or passive feedback 510. For instance, a sample pair 512 may comprise a historical target data input and/or a reference entry matched to the historical target data input. In some examples, the feedback 510 may comprise an indication of the accuracy of the reference entry for the historical target data input. By way of example, the feedback 510 may comprise human in the loop (HITL) feedback that may verify and/or reject a sample pair 512 to create and/or augment the labeled training dataset 502 over time.

More particularly, the labeled training dataset 502 may comprise a set of positively and negatively labeled training samples that may serve as a foundation for training the machine learned classifier 424. To enable the machine learned classifier 424 to learn to distinguish between correct and incorrect matches, the labeled training dataset 502 may comprise examples of both positive (e.g., correct) and negative (e.g., incorrect) matches from which the model may learn patterns and decision boundaries. The labeled training dataset 502 may comprise a structured collection of data, such as CSV, JSON, and/or other specialized machine learning dataset formats. The structured collection of data may define a set of training samples that each comprise a sample pair 512 and a label. A positive training sample 506 may comprise a negative label. A negative training sample 504 may comprise a positive label.

In some examples, the labeled training dataset 502 may comprise a training subset and/or a validation subset. Each subset may provide the ground truths that allows the machine learned classifier 424 to learn the characteristics of correct and/or incorrect matches during training and then verify the performance of the machine learned classifier 424 after training. In this way, the labeled training dataset 502 may enable supervised learning approaches, supporting model evaluation and performance measurement, and allowing for iterative improvement of the machine learned classifier 424 through analysis of model errors on the training data. By way of example, the machine learned classifier 424 may be trained using backpropagation of errors, optimized using gradient descent, to minimize a classification loss function, such as binary cross-entropy, and/or the like. The classification loss function, for example, may be determined based on a comparison between the ground truths (e.g., positive and/or negative labels) within the labeled training dataset 502 and/or the training match probability scores output by the machine learned classifier 424.

In addition, or alternatively, the machine learned classifier 424 may be trained using one or more semi-supervised learning techniques that leverage both labeled and unlabeled data, and/or active learning approaches that selectively label the most informative examples to improve model performance efficiently. By way of example, as described herein, the computing system 101 may implement continuous learning pipelines that automatically incorporate new labeled data as it becomes available through feedback 510 and/or manual review processes.

In some embodiments, a positive training sample 506 of the subset of positive training samples may comprise a training vector. The training vector may be derived from a training input sample and a reference entry of the sample pair 512. In some examples, the training vector comprises a similarity metric, a genericism metric, a target contextual attribute, and/or an entry contextual attribute corresponding to the sample pair 512. In addition, or alternatively, the positive training sample 506 may comprise a positive label indicating that the training input sample corresponds to the reference entry.

More particularly, the positive training sample 506 may comprise a training sample with a sample pair 512 that is positively identified as matching. By way of example, the positive training sample 506 may comprise an input vector corresponding to a sample pair 512 and a positive label. Positive training samples 506 may serve as examples of correct matches, helping the machine learned classifier 424 learn the characteristics and patterns associated with true positive matches.

In some embodiments, a negative training sample 504 of the subset of negative training samples may comprise a training vector that is derived from a training input sample and a reference entry of the sample pair 512. In some examples, the training vector comprises a similarity metric, a genericism metric, a target contextual attribute, and/or an entry contextual attribute corresponding to the sample pair 512. In addition, or alternatively, the negative training sample 504 may comprise a negative label indicating that the training input sample fails to correspond to the reference entry.

More particularly, the negative training sample 504 may comprise a training sample with a sample pair 512 that is negatively identified as not matching. By way of example, the negative training sample 504 may comprise an input vector corresponding to a sample pair 512 and a negative label. Negative training samples 504 may serve as examples of incorrect matches, helping the machine learned classifier 424 learn to distinguish between true matches and similar but distinct entries. The incorporation of the negative training samples 504 to the labeled training dataset 502 helps prevent overfitting by improving the machine learned classifier's 424 ability to reject false positives. The functionality of negative training samples includes providing examples of common error cases, helping the machine learned classifier 424 learn to distinguish between superficial similarities and true matches, and improving the overall precision of the matching process.

In some embodiments, the labeled training dataset 502 comprises a distribution of training samples that is evenly divided between negative and positive training samples. In addition, or alternatively, the training samples may be further divided across one or more similarity ranges to prevent overfitting to the similarity metric. For example, a subset of negative training samples may comprise a first plurality negative training samples with a first plurality of similarity metrics each exceeding a training similarity threshold. In addition, or alternatively, the subset of negative training samples may comprise a second plurality negative training samples with a second plurality of similarity metrics each failing to meet or exceed the training similarity threshold. In some examples, the training similarity threshold is based on the first similarity threshold. By way of example, the training similarity threshold may be the same and/or an order of magnitude higher than the first similarity threshold.

In some embodiments, the training similarity threshold comprises similarity threshold used to separate the negative training samples into high similarity and low similarity subgroups to further prevent overfitting to the similarity metric within the training samples. A training similarity threshold serves as a tool for creating a more balanced and informative set of negative training samples, improving the robustness and generalization ability of the machine learned classifier 424. The training similarity threshold may comprise fixed value (e.g., 0.8) determined through empirical analysis, and/or a dynamically set value based on the distribution of similarity scores in the labeled training dataset 502.

In some examples, the training similarity threshold may be used to create a more nuanced set of negative training samples 504. By separating negative training samples 504 into high and low similarity subgroups, the training similarity threshold may enable the machine learned classifier 424 to learn more fine-grained decision boundaries, particularly for cases where entries have a high similarity metric but do not match. The functionality of the training similarity threshold includes preventing the model from overly relying on simple similarity metrics, encouraging it to learn more complex patterns that distinguish true matches from high-similarity non-matches.

In some examples, the training similarity threshold may define a plurality of thresholds to create more granular subgroups of negative samples. In addition, or alternatively, the computing system 101 may implement adaptive thresholds that adjust based on the characteristics of the specific matching task and/or dataset. In some examples, the training similarity threshold may be implemented in conjunction with other criteria, such as contextual attributes, to create more diverse and informative sets of negative training samples 504.

In some embodiments, one or more synthetic negative training samples 514 may be generated to improve the distribution and/or diversity of the training samples within the labeled training dataset 502. For example, the first and/or second plurality negative training samples may comprise a synthetic negative training sample that is generated by perturbing a training input sample to increase and/or decrease a similarity metric or other attribute of the training sample.

In some embodiments, the synthetic negative training sample 514 comprises a synthetic training sample that is modified to boost the machine learned classifier's 424 performance with respect to certain tasks, such as the determination of an unrelated reference entry with a high similarity score. Synthetic negative training samples 514 serve as artificially created examples of challenging non-matches, helping to improve the machine learned classifier's 424 ability to handle edge cases and/or ambiguous situations. By way of example, the computing system 101 may generate the synthetic negative training samples 514 through random sampling, targeted perturbation of positive and/or negative samples, and/or the like. In some examples, the computing system 101 may implement hard negative mining, where the most challenging negative samples (e.g., those that the machine learned classifier 424 is most likely to misclassify) are given more weight during training.

In some examples, computing system 101 may generate the synthetic negative training samples 514 by modifying existing samples and/or create new samples based on patterns in the data. By way of example, the computing system 101 may perturbed the input vector of an existing training sample pair 512 to increase a similarity metric, decrease the similarity metric, modify the genericism metric, replace a target contextual attribute or entry contextual attribute, and/or the like. By doing so, the computing system 101 may generate an entirely new, realistic negative sample to improve the data distribution within the labeled training dataset 502.

In this way, the computing system 101 may generate synthetic negative training samples 514 to enhance the labeled training dataset 502 by balancing areas where real world negative samples may be scarce and/or not sufficiently challenging. By doing so, the synthetic negative training samples 514 may improve the machine learned classifier's 424 robustness and generalization ability, such as for edge cases that may be rare in real-world data. This, in turn, enables the machine learned classifier 424 to learn more nuanced decision boundaries, improving its performance on challenging cases, and reducing overfitting to patterns in the natural training data.

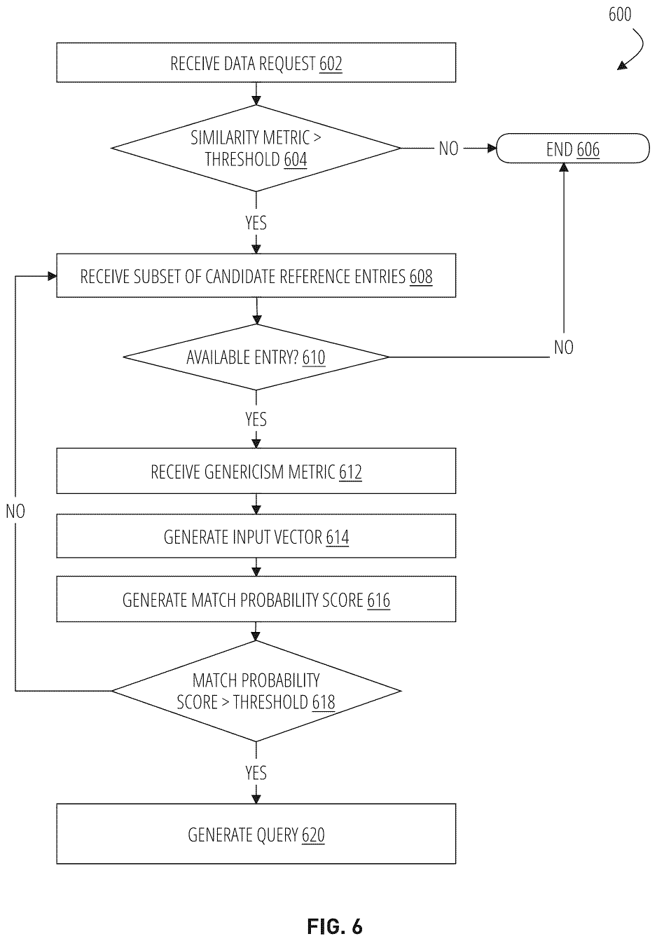

FIG. 6 depicts a flowchart diagram of two-stage query handling process 600 in accordance with some embodiments of the present disclosure. The flowchart diagram depicts a data processing technique for improving query resolution accuracy, while reducing null results. The process 600 may be implemented by one or more computing devices, entities, and/or systems described herein. For example, via the various steps/operations of the process 600, the computing system 101 may process a query through a two-staged approach that merges contrasting signals into a machine learning framework to simultaneously reduce null results and improve the accuracy of a data matches. By doing so, the process 600 improves computer functionality by improving querying speeds and increase the accuracy of query resolutions from external data sources.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving a data request. For example, the computing system 101 may receive a data request that comprises a target data input and/or a target contextual attribute for the target data input. The target data input, for example, may comprise a text string, a bounding box, and/or an audio snippet.

In some embodiments, the process 600 comprises, at operation 604, determines whether at least one reference entry from a reference dataset meets or exceeds a first similarity threshold in accordance with a search stage of the process 600. In some examples, the target data input may comprise a text string and the similarity metric may comprise a Levenshtein distance and/or a Jacquard distance between the target data input and an entry name of a reference entry that is determined for up to each reference entry within a reference dataset.

In the event that at least one reference entry meets or exceeds the first similarity threshold, the process 600 may proceed to operation 608, where a subset of candidate reference entries is received for the data request. In addition, or alternatively, in the event that no reference entry from the reference dataset meets or exceeds the first similarity threshold, the process 600 may proceed to operation 606, where the process 600 may end without initiating a query for the data request. For example, at operation 606, the data request may be provided to an agent for manual review.

In some embodiments, the process 600 comprises, at operation 608, receiving a subset of candidate reference entries. For example, the computing system 101 may receive a subset of candidate reference entries from a reference dataset based on the target data input. Up to each candidate reference entry of the subset of candidate reference entries may be associated with a similarity metric that meets or exceeds the first similarity threshold.

In some embodiments, the process 600 comprises, at operation 610, determining whether an unprocessed reference entry from the subset of candidate reference entries exists. In the event that an unprocessed reference entry does not exist, the process 600 may proceed to operation 606, where the process 600 may end without initiating a query for the data request. For example, at operation 606, the data request may be provided to an agent for manual review. In addition, or alternatively, in the event that an unprocessed reference entry does exist, the process 600 may proceed to operation 612, where the process 600 comprises receiving genericism metric.

In some embodiments, the process 600 comprises, at operation 612, receiving a genericism metric. For example, the computing system 101 may receive the genericism metric for the candidate reference entry. The genericism metric, for example, may be based on a frequency of at least a portion of the entry name of the candidate reference entry. In some examples, the target contextual attribute and/or an entry contextual attribute of the reference entry may identify a geographic location. The genericism metric may be based on a frequency of at least the portion of the entry name within a subset of the reference dataset that corresponds to the geographic location. In some examples, the genericism metric may be received from an intermediate lookup table that comprises a predetermined genericism metric for up to each reference entry within the reference dataset. The intermediate lookup table, for example, may be updated at a defined frequency to ensure an accurate representation of the data stored within the data source.

In some embodiments, the process 600 comprises, at operation 614, generating an input vector. For example, the computing system 101 may generate an input vector for the candidate reference entry by concatenating the similarity metric, the genericism metric, the target contextual attribute, and an entry contextual attribute.

In some embodiments, the process 600 comprises, at operation 616, generating a match probability score. For example, the computing system 101 may generate, using a machine learned classifier, a match probability score for the candidate reference entry based on the input vector.

In some examples, the machine learned classifier comprises a binary classifier that is trained using a labeled training dataset. The labeled training dataset may comprise a first subset of positive training samples and/or a second subset of negative training samples.

For example, a positive training sample of the subset of positive training samples may comprise a first training vector that is (a) derived from a first training input sample and a first reference entry of the reference dataset and (b) comprises a first similarity metric, a first genericism metric, a first input contextual attribute, and a first entry contextual attribute. In addition, or alternatively, the positive training sample may comprise a positive label indicating that the first training input sample corresponds to the first reference entry.

As another example, a negative training sample of the subset of negative training samples may comprise a second training vector that is (a) derived from a second training input sample and a second reference entry of the reference dataset and/or (b) comprises a second similarity metric, a second genericism metric, a second input contextual attribute, and a second entry contextual attribute. In addition, or alternatively, the negative training sample may comprise a negative label indicating that the second training input sample is distinct from the second reference entry.

In some examples, the subset of negative training samples may comprise a first plurality negative training samples with a first plurality of second similarity metrics each exceeding a training similarity threshold. In addition, or alternatively, the subset of negative training samples may comprise a second plurality negative training samples with a second plurality of second similarity metrics each failing to meet or exceed the training similarity threshold. The training similarity threshold, for example, may be higher than the first similarity threshold. In some examples, the first and/or second plurality negative training samples comprises a synthetic negative training sample that is generated by perturbing a training input sample to increase or decrease a similarity metric or other attribute of the training sample.

In some embodiments, the process 600 comprises, at operation 618, determining whether at least one reference entry from the subset of candidate reference entries meets or exceeds a second similarity threshold. In the event that at least one reference entry meets or exceeds the second similarity threshold, the process 600 may proceed to operation 620, where a query is generated for the data request. In addition, or alternatively, in the event that no reference entry from the subset of candidate reference entries meets or exceeds the second similarity threshold, the process 600 may proceed to operation 606, where the process 600 may end without initiating the query for the data request. For example, at operation 606, the data request may be provided to an agent for manual review.

In some embodiments, the process 600 comprises, at operation 620, in response to a determination that the match probability score meets or exceeds a second similarity threshold, providing the candidate reference entry in response to the data request. For example, the computing system 101 may, in response to the determination that the match probability score meets or exceeds the second similarity threshold, provide the candidate reference entry in response to the data request.

In some embodiments, the reference dataset is stored on an external data source. The process 600 may, in response to the determination that the match probability score meets or exceeds the second similarity threshold, generate a query for the external data source based on the candidate reference entry and execute the query to receive and/or verify an attribute of the target data input.

Some techniques of the present disclosure enable the generation of action outputs that may be performed to initiate one or more real world actions to achieve real-world effects. The techniques of the present disclosure may be used, applied, and/or otherwise leveraged to execute queries to a data source, and/or other robotic device. In some examples, the queries of the present disclosure may trigger action outputs (e.g., through control instructions) to automate computer performance actions, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, a data request that comprises a target data input and a target contextual attribute for the target data input; receiving, by one or more processors, a subset of candidate reference entries from a reference dataset based on the target data input, wherein a candidate reference entry of the subset of candidate reference entries is associated with a similarity metric that meets or exceeds a first similarity threshold; receiving, by the one or more processors, a genericism metric for the candidate reference entry, wherein the genericism metric is based on a frequency of at least a portion of an entry name of the candidate reference entry; generating, by the one or more processors, an input vector for the candidate reference entry by concatenating the similarity metric, the genericism metric, the target contextual attribute, and an entry contextual attribute; generating, by the one or more processors and using a machine learned classifier, a match probability score for the candidate reference entry based on the input vector; and in response to a determination that the match probability score meets or exceeds a second similarity threshold, providing, by the one or more processors, the candidate reference entry in response to the data request.

Example 2. The computer-implemented method of example 1, wherein the machine learned classifier comprises a binary classifier that is trained using a labeled training dataset and the labeled training dataset comprises a subset of positive training samples and a subset of negative training samples.

Example 3. The computer-implemented method of example 2, wherein (i) a positive training sample of the subset of positive training samples comprises (1) a first training vector that is (a) derived from a first training input sample and a first reference entry of the reference dataset and (b) comprises a first similarity metric, a first genericism metric, a first input contextual attribute, and a first entry contextual attribute, and (2) a positive label indicating that the first training input sample corresponds to the first reference entry, and (ii) a negative training sample of the subset of negative training samples comprises (1) a second training vector that is (a) derived from a second training input sample and a second reference entry of the reference dataset and (b) comprises a second similarity metric, a second genericism metric, a second input contextual attribute, and a second entry contextual attribute, and (2) a negative label indicating that the second training input sample is distinct from the second reference entry.

Example 4. The computer-implemented method of example 3, wherein the subset of negative training samples comprises (1) a first plurality negative training samples with a first plurality of second similarity metrics each exceeding a training similarity threshold and (2) a second plurality negative training samples with a second plurality of second similarity metrics each failing to meet or exceed the training similarity threshold.

Example 5. The computer-implemented method of example 4, wherein the first plurality negative training samples comprises a synthetic negative training sample that is generated by perturbing the second training input sample to increase the second similarity metric.

Example 6. The computer-implemented method of examples 4 or 5, wherein the training similarity threshold is higher than the first similarity threshold.

Example 7. The computer-implemented method of any of the preceding examples, wherein the target data input comprises a text string, a bounding box, or an audio snippet.

Example 8. The computer-implemented method of example 7, wherein the target data input comprises the text string and the similarity metric comprises a Levenshtein distance or a Jacquard distance between the target data input and the entry name of the candidate reference entry.

Example 9. The computer-implemented method of any of the preceding examples, wherein the target contextual attribute and the entry contextual attribute identify a geographic location, and the genericism metric is based on a frequency of at least the portion of the entry name within a subset of the reference dataset that corresponds to the geographic location.

Example 10. The computer-implemented method of any of the preceding examples, wherein the genericism metric is received from an intermediate lookup table that comprises a predetermined genericism metric for each reference entry within the reference dataset, and the intermediate lookup table is updated at a defined frequency.

Example 11. The computer-implemented method of any of the preceding examples, wherein the reference dataset is stored on an external data source, and the computer-implemented method further comprises in response to the determination that the match probability score meets or exceeds the second similarity threshold, generating a query for the external data source based on the candidate reference entry and executing the query to receive or verify an attribute of the target data input.

Example 12. A system comprising one or more processors; and one or more memories storing processor-executable instructions that, when executed by the one or more processors, cause the one or more processors to perform operations comprising receiving a data request that comprises a target data input and a target contextual attribute for the target data input; receiving a subset of candidate reference entries from a reference dataset based on the target data input, wherein a candidate reference entry of the subset of candidate reference entries is associated with a similarity metric that meets or exceeds a first similarity threshold; receiving a genericism metric for the candidate reference entry, wherein the genericism metric is based on a frequency of at least a portion of an entry name of the candidate reference entry; generating an input vector for the candidate reference entry by concatenating the similarity metric, the genericism metric, the target contextual attribute, and an entry contextual attribute; generating, using a machine learned classifier, a match probability score for the candidate reference entry based on the input vector; and in response to a determination that the match probability score meets or exceeds a second similarity threshold, providing the candidate reference entry in response to the data request.

Example 13. The system of example 12, wherein the machine learned classifier comprises a binary classifier that is trained using a labeled training dataset and the labeled training dataset comprises a subset of positive training samples and a subset of negative training samples.

Example 14. The system of example 13, wherein (i) a positive training sample of the subset of positive training samples comprises (1) a first training vector that is (a) derived from a first training input sample and a first reference entry of the reference dataset and (b) comprises a first similarity metric, a first genericism metric, a first input contextual attribute, and a first entry contextual attribute, and (2) a positive label indicating that the first training input sample corresponds to the first reference entry, and (ii) a negative training sample of the subset of negative training samples comprises (1) a second training vector that is (a) derived from a second training input sample and a second reference entry of the reference dataset and (b) comprises a second similarity metric, a second genericism metric, a second input contextual attribute, and a second entry contextual attribute, and (2) a negative label indicating that the second training input sample is distinct from the second reference entry.

Example 15. The system of example 14, wherein the subset of negative training samples comprises (1) a first plurality negative training samples with a first plurality of second similarity metrics each exceeding a training similarity threshold and (2) a second plurality negative training samples with a second plurality of second similarity metrics each failing to meet or exceed the training similarity threshold.

Example 16. The system of example 15, wherein the first plurality negative training samples comprises a synthetic negative training sample that is generated by perturbing the second training input sample to increase the second similarity metric.

Example 17. The system of examples 15 or 16, wherein the training similarity threshold is higher than the first similarity threshold.

Example 18. One or more non-transitory computer-readable media storing processor-executable instructions that, when executed by one or more processors, cause the one or more processors to perform operations comprising receiving a data request that comprises a target data input and a target contextual attribute for the target data input; receiving a subset of candidate reference entries from a reference dataset based on the target data input, wherein a candidate reference entry of the subset of candidate reference entries is associated with a similarity metric that meets or exceeds a first similarity threshold; receiving a genericism metric for the candidate reference entry, wherein the genericism metric is based on a frequency of at least a portion of an entry name of the candidate reference entry; generating an input vector for the candidate reference entry by concatenating the similarity metric, the genericism metric, the target contextual attribute, and an entry contextual attribute; generating, using a machine learned classifier, a match probability score for the candidate reference entry based on the input vector; and in response to a determination that the match probability score meets or exceeds a second similarity threshold, providing the candidate reference entry in response to the data request.

Example 19. The one or more non-transitory computer-readable media of example 18, wherein the target data input comprises a text string, a bounding box, or an audio snippet.

Example 20. The one or more non-transitory computer-readable media of example 19, wherein the target data input comprises the text string and the similarity metric comprises a Levenshtein distance or a Jacquard distance between the target data input and the entry name of the candidate reference entry.

Example 21. The computer-implemented method of example 1, wherein the method further comprises training the machine learned classifier.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 12, wherein the one or more processors are further configured to train the machine learned classifier.

Example 25. The computing system of example 24, wherein the one or more processors are comprised in a first computing entity; and the machine learned classifier is trained by one or more other processors comprised in a second computing entity.

Example 26. The one or more non-transitory computer-readable storage media of example 18, wherein the instructions further cause the one or more processors to train the machine learned classifier.

Example 27. The one or more non-transitory computer-readable storage media of example 26, wherein the one or more processors are comprised in a first computing entity; and the machine learned classifier is trained by one or more other processors comprised in a second computing entity.

1. A computer-implemented method comprising:
receiving, by one or more processors, a data request that comprises a target data input and a target contextual attribute for the target data input;
receiving, by one or more processors, a subset of candidate reference entries from a reference dataset based on the target data input, wherein a candidate reference entry of the subset of candidate reference entries is associated with a similarity metric that meets or exceeds a first similarity threshold;
receiving, by the one or more processors, a genericism metric for the candidate reference entry, wherein the genericism metric is based on a frequency of at least a portion of an entry name of the candidate reference entry;
generating, by the one or more processors, an input vector for the candidate reference entry by concatenating the similarity metric, the genericism metric, the target contextual attribute, and an entry contextual attribute, wherein the genericism metric counterbalances the similarity metric based on a prevalence of the candidate reference entry within the reference dataset;
generating, by the one or more processors and using a machine learned classifier, a match probability score for the candidate reference entry based on the input vector; and
in response to a determination that the match probability score meets or exceeds a second similarity threshold, providing, by the one or more processors, the candidate reference entry in response to the data request.

2. The computer-implemented method of claim 1, wherein the machine learned classifier comprises a binary classifier that is trained using a labeled training dataset and the labeled training dataset comprises a subset of positive training samples and a subset of negative training samples.

3. The computer-implemented method of claim 2, wherein:
(i) a positive training sample of the subset of positive training samples comprises (1) a first training vector that is (a) derived from a first training input sample and a first reference entry of the reference dataset and (b) comprises a first similarity metric, a first genericism metric, a first input contextual attribute, and a first entry contextual attribute, and (2) a positive label indicating that the first training input sample corresponds to the first reference entry, and (ii) a negative training sample of the subset of negative training samples comprises (1) a second training vector that is (a) derived from a second training input sample and a second reference entry of the reference dataset and (b) comprises a second similarity metric, a second genericism metric, a second input contextual attribute, and a second entry contextual attribute, and (2) a negative label indicating that the second training input sample is distinct from the second reference entry.

4. The computer-implemented method of claim 3, wherein the subset of negative training samples comprises (1) a first plurality negative training samples with a first plurality of second similarity metrics each exceeding a training similarity threshold and (2) a second plurality negative training samples with a second plurality of second similarity metrics each failing to meet or exceed the training similarity threshold.

5. The computer-implemented method of claim 4, wherein the first plurality negative training samples comprises a synthetic negative training sample that is generated by perturbing the second training input sample to increase the second similarity metric.

6. The computer-implemented method of claim 4, wherein the training similarity threshold is higher than the first similarity threshold.

7. The computer-implemented method of claim 1, wherein the target data input comprises a text string, a bounding box, or an audio snippet.

8. The computer-implemented method of claim 7, wherein the target data input comprises the text string and the similarity metric comprises a Levenshtein distance or a Jacquard distance between the target data input and the entry name of the candidate reference entry.

9. The computer-implemented method of claim 1, wherein the target contextual attribute and the entry contextual attribute identify a geographic location, and the genericism metric is based on a frequency of at least the portion of the entry name within a subset of the reference dataset that corresponds to the geographic location.

10. The computer-implemented method of claim 1, wherein the genericism metric is received from an intermediate lookup table that comprises a predetermined genericism metric for each reference entry within the reference dataset, and the intermediate lookup table is updated at a defined frequency.

11. The computer-implemented method of claim 1, wherein the reference dataset is stored on an external data source, and the computer-implemented method further comprises:
in response to the determination that the match probability score meets or exceeds the second similarity threshold, generating a query for the external data source based on the candidate reference entry and executing the query to receive or verify an attribute of the target data input.

12. A system comprising:
one or more processors; and
one or more memories storing processor-executable instructions that, when executed by the one or more processors, cause the one or more processors to perform operations comprising:
receiving a data request that comprises a target data input and a target contextual attribute for the target data input;
receiving a subset of candidate reference entries from a reference dataset based on the target data input, wherein a candidate reference entry of the subset of candidate reference entries is associated with a similarity metric that meets or exceeds a first similarity threshold;
receiving a genericism metric for the candidate reference entry, wherein the genericism metric is based on a frequency of at least a portion of an entry name of the candidate reference entry;
generating an input vector for the candidate reference entry by concatenating the similarity metric, the genericism metric, the target contextual attribute, and an entry contextual attribute, wherein the genericism metric counterbalances the similarity metric based on a prevalence of the candidate reference entry within the reference dataset;
generating, using a machine learned classifier, a match probability score for the candidate reference entry based on the input vector; and
in response to a determination that the match probability score meets or exceeds a second similarity threshold, providing the candidate reference entry in response to the data request.

13. The system of claim 12, wherein the machine learned classifier comprises a binary classifier that is trained using a labeled training dataset and the labeled training dataset comprises a subset of positive training samples and a subset of negative training samples.

14. The system of claim 13, wherein:
(i) a positive training sample of the subset of positive training samples comprises (1) a first training vector that is (a) derived from a first training input sample and a first reference entry of the reference dataset and (b) comprises a first similarity metric, a first genericism metric, a first input contextual attribute, and a first entry contextual attribute, and (2) a positive label indicating that the first training input sample corresponds to the first reference entry, and (ii) a negative training sample of the subset of negative training samples comprises (1) a second training vector that is (a) derived from a second training input sample and a second reference entry of the reference dataset and (b) comprises a second similarity metric, a second genericism metric, a second input contextual attribute, and a second entry contextual attribute, and (2) a negative label indicating that the second training input sample is distinct from the second reference entry.

15. The system of claim 14, wherein the subset of negative training samples comprises (1) a first plurality negative training samples with a first plurality of second similarity metrics each exceeding a training similarity threshold and (2) a second plurality negative training samples with a second plurality of second similarity metrics each failing to meet or exceed the training similarity threshold.

16. The system of claim 15, wherein the first plurality negative training samples comprises a synthetic negative training sample that is generated by perturbing the second training input sample to increase the second similarity metric.

17. The system of claim 15, wherein the training similarity threshold is higher than the first similarity threshold.

18. One or more non-transitory computer-readable media storing processor-executable instructions that, when executed by one or more processors, cause the one or more processors to perform operations comprising:
receiving a data request that comprises a target data input and a target contextual attribute for the target data input;
receiving a subset of candidate reference entries from a reference dataset based on the target data input, wherein a candidate reference entry of the subset of candidate reference entries is associated with a similarity metric that meets or exceeds a first similarity threshold;
receiving a genericism metric for the candidate reference entry, wherein the genericism metric is based on a frequency of at least a portion of an entry name of the candidate reference entry;
generating an input vector for the candidate reference entry by concatenating the similarity metric, the genericism metric, the target contextual attribute, and an entry contextual attribute, wherein the genericism metric counterbalances the similarity metric based on a prevalence of the candidate reference entry within the reference dataset;
generating, using a machine learned classifier, a match probability score for the candidate reference entry based on the input vector; and
in response to a determination that the match probability score meets or exceeds a second similarity threshold, providing the candidate reference entry in response to the data request.

19. The one or more non-transitory computer-readable media of claim 18, wherein the target data input comprises a text string, a bounding box, or an audio snippet.

20. The one or more non-transitory computer-readable media of claim 19, wherein the target data input comprises the text string and the similarity metric comprises a Levenshtein distance or a Jacquard distance between the target data input and the entry name of the candidate reference entry.
